(19) United States
(12) Patent Application Publication
(10) Pub. No.: US 2026/0156114 A1
(43) Pub. Date: Jun. 4, 2026

(54) Local Authorization for AI/ML Model Storage and Sharing

(71) Applicant: Telefonaktiebolaget LM Ericsson (publ), Stockholm (SE)

(72) Inventors: Cheng Wang, Shanghai (CN); Christine Jost, Lund (SE); Ferhat Karakoc, Istanbul (TR); Songmao Li, Shanghai (CN); Dan Xu, Göteborg (SE); Ulf Mattsson, Göteborg (SE); Jing Yue, Stockholm (SE)

(21) Appl. No.: 19/123,559

(22) PCT Filed: Nov. 2, 2023
(86) PCT No.: PCT/EP2023/080572

§ 371 Date: Apr. 23, 2025

(30) Foreign Application Priority Data
Nov. 7, 2022 (WO) PCT/CN2022/130359

(51) Int. Cl. H04L 9/40

(52) U.S. Cl. CPC H04L 63/10

(57) ABSTRACT

Embodiments include methods for a consumer network function (NFc). Such methods include registering the following with a network repository function (NRF): a vendor identifier (ID) associated with the NFc; and one or more analytics IDs associated with ML models supported by the NFc, including a first analytics ID associated with a first ML model produced, owned, and/or maintained by a producer NF (NFp). Such methods include sending a request for the first ML model to the NFp. The request includes the first analytics ID and the vendor ID associated with the NFc. Such methods include receiving from the NFp a response including a universal resource locator associated with a second NF, from which the ML model can be obtained. Other embodiments include complementary methods for an NFp, an NRF, and an ADRF of the communication network, as well as network nodes or functions configured to perform such methods.

### TECHNICAL FIELD

The present application relates generally to the field of communication networks, and more specifically to techniques for security of artificial intelligence/machine learning (AI/ML) models used to generate analytics in a communication network (e.g., a 5G core network).

### INTRODUCTION

Currently the fifth generation (5G) of cellular systems is being standardized within the Third-Generation Partnership Project (3GPP). 5G is developed for maximum flexibility to support various use cases including enhanced mobile broadband (eMBB), machine type communications (MTC), ultra-reliable low latency communications (URLLC), side-link device-to-device (D2D), and several other use cases.

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G network architecture, which includes a Next Generation Radio Access Network (NG-RAN, 199) and a 5G Core (5GC, 198). The NG-RAN can include one or more gNodeB's (gNBs, e.g., 100, 150) connected to the 5GC via one or more NG interfaces (e.g., 102, 152). More specifically, the gNBs can be connected to one or more Access and Mobility Management Functions (AMFs) in the 5GC via respective NG-C interfaces and to one or more User Plane Functions (UPFs) in the 5GC via respective NG-U interfaces. Various other network functions (NFs) can be included in the 5GC, as described in more detail below.

In addition, the gNBs can be connected to each other via one or more Xn interfaces (e.g., 140 between gNBs 100, 150). The radio technology for the NG-RAN is often referred to as New Radio (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG RAN logical nodes shown in FIG. 1 include a Centralized Unit (CU or gNB-CU) and one or more Distributed Units (DU or gNB-DU). CUs (e.g., 110) are logical nodes that host higher-layer protocols and perform various gNB functions such controlling the operation of DUs. In contrast, DUs (e.g., 120, 130) are decentralized logical nodes that host lower layer protocols and can include, depending on the functional split option, various subsets of gNB functions. A CU connects to one or more DUs over respective F1 logical interfaces (e.g., 122, 132 in FIG. 1).

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations,” which are more granular divisions of the overall service functionality. The interactions between service consumers and producers can be of the type “request/response” or “subscribe/notify.” In the 5G SBA, network repository functions (NRF) allow every network function to discover the services offered by other network functions, and Data Storage Functions (DSF) allow every network function to store its context. This 5G SBA model is based on principles including modularity, reusability, and self-containment of NFs, which can enable network deployments to take advantage of the latest virtualization and software technologies.

A 5GC NF that is of particular interest in the present disclosure is the Network Data Analytics Function (NWDAF). This NF provides network analytics information (e.g., statistical information of past events and/or predictive information) to other NFs on a network slice instance level. The NWDAF can collect data from any 5GC NF. Note that a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice.

Machine learning (ML) is a type of artificial intelligence (AI) that focuses on the use of data and algorithms to imitate the way that humans learn, gradually improving accuracy as more data becomes available. ML algorithms build models based on sample (or “training”) data, with the models being used subsequently to make predictions or decisions. ML algorithms can be used in a wide variety of applications (e.g., medicine, email filtering, speech recognition, etc.) in which it is difficult or unfeasible to develop conventional algorithms to perform the needed tasks. A subset of ML is closely related to computational statistics.

The 5G system architecture allows any NF to obtain analytics from an NWDAF using a Data Collection Coordination Function (DCCF) and associated Ndccf services. The NWDAF can also store and retrieve analytics information from an Analytics Data Repository Function (ADRF). 3GPP TS 23.288 (v17.2.0) specifies that NWDAF is the main NF for computing analytics reports, and classifies NWDAF into two sub-functions (or logical functions): Analytics Logical Function (AnLF), which performs analytics procedures; and Model Training Logical Function (MTLF), which performs training and retraining of ML models used by the AnLF.

### SUMMARY

AI/ML models (or more simply, ML models) are considered important intellectual property of their owners (e.g., 5GC vendors) and, as such, must have their confidentiality and integrity protected at all times. 3GPP is studying the feasibility of sharing or storing ML models in network equipment that may be provided by different vendors. In this arrangement, an ML model should be protected from access and use by consumer NFs that are provided by different vendors than the ML model's vendor. Currently, however, there are no specified solutions to this requirement.

An object of embodiments of the present disclosure is to address these and other problems, issues, and/or difficulties related to ML model security, thereby facilitating the otherwise-advantageous deployment of ML models for network analytics.

Some embodiments of the present disclosure include methods (e.g., procedures) for a consumer NF (NFc) of a communication network (e.g., 5GC).

These exemplary methods include registering the following information with a network repository function (NRF) of the communication network: a vendor identifier (ID) associated with the NFc, and one or more analytics IDs associated with ML models supported by the NFC, including a first analytics ID associated with a first ML model produced, owned, and/or maintained by a producer NF (NFp) of the communication network. These exemplary methods also include sending a request for the first ML model to the NFp. The request includes the first analytics ID and the vendor ID associated with the NFc. These exemplary methods also include receiving from the NFp a response that includes a URL associated with a second NF of the communication network, from which the ML model can be obtained.

In some embodiments, these exemplary methods also include obtaining the ML model from the second NF using the URL. In some embodiments, the second NF associated with the URL is one of the following: the NFp, or an analytics data repository function (ADRF) of the communication network.

Other embodiments include exemplary methods (e.g., procedures) for an NFp of a communication network (e.g., 5GC).

These exemplary methods can include receiving, from an NFc of the communication network, a request for an ML model produced, owned, and/or maintained by the NFp. The request includes a first analytics ID associated with the ML model and a vendor ID associated with the NFc. These exemplary methods also include obtaining a profile associated with the NFc from an NRF of the communication network. These exemplary methods also include authorizing the NFc to access the ML model based on a match, correspondence, or relationship between a vendor ID included in the retrieved NF profile and the vendor ID included in the request. These exemplary methods also include, based on authorizing the NFc, sending to the NFc a response that includes a URL associated with a second NF of the communication network, from which the ML model can be obtained.

In some embodiments, the second NF associated with the URL is the NFp, and these exemplary methods also include providing the ML model to the NFc using the URL associated with the NFp. In some of these embodiments, providing the ML model to the NFc is based on a match, correspondence, or relationship between an identifier associated with the NFc and an allowed NF instance list associated with the ML model.

In other embodiments, the second NF associated with the URL is an ADRF of the communication network.

Other embodiments include methods (e.g., procedures) for an NRF of a communication network (e.g., 5GC).

These exemplary methods can include registering the following information in a profile for an NFc of the communication network: a vendor ID associated with the NFc, and one or more analytics IDs associated with ML models supported by the NFc, including a first analytics ID associated with a first ML model produced, owned, and/or maintained by an NFp of the communication network. These exemplary methods also include receiving from the NFp a request for the profile for the NFc and sending the profile for the NFc to the NFp, in response to the request.

In some embodiments, these exemplary methods also include performing a discovery procedure with the NFc to identify the NFp based on the first analytics ID.

Other embodiments include methods (e.g., procedures) for an ADRF of a communication network (e.g., 5GC).

These exemplary methods include receiving, from an NFp of the communication network, a first request to store an ML model. The first request includes a correlation ID associated with the ML model and a URL associated with the NFp, from which the ML model can be obtained. These exemplary methods also include obtaining the ML model from the NFp using the URL associated with the NFp and storing the obtained ML model in association with the correlation ID. These exemplary methods also include sending to the NFp a first response including a URL associated with the ADRF, from which the ML model can be obtained.

In some embodiments, these exemplary methods also include receiving from the NFp an update request that includes the correlation ID and an allowed NF instance list and, based on a match between the correlation ID included with the update request and the correlation ID stored in association with the ML model, storing the allowed NF instance list in association with the ML model. In particular, the allowed NF instance list includes one or more identifiers associated with respective NFs of the communication network that are allowed to access the ML model.

In some of these embodiments, these exemplary methods also include providing the ML model to an NFc of the communication network using the URL associated with the ADRF. In some of these embodiments, providing the ML model to the NFc is based on a match, correspondence, or relationship between an identifier associated with the NFc and an identifier included in an allowed NF instance list stored in association with the ML model.

In various embodiments summarized above, the NFc may be an NWDAF(AnLF) and/or the NFp may be an NWDAF(MTLF).

Other embodiments include NFc's, NFp's, NRFs, and ADRFs (or network equipment configured to implement such NFs) that are configured to perform the operations corresponding to any of the exemplary methods described herein. Other embodiments also include non-transitory, computer-readable media storing computer-executable instructions that, when executed by processing circuitry, configure such NFs to perform operations corresponding to any of the exemplary methods described herein.

These and other disclosed embodiments can provide various benefits and/or advantages. By providing an ML model owner/producer with the ability to protect the ML model during various transfer, storage, and retrieval scenarios, embodiments improve the security of confidential and/or sensitive ML models and thereby facilitate deployment of such models in a multi-vendor communication network, such as 5GC.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows a signaling diagram of a network procedure for authorization and authentication of AI/ML model transfer.

FIG. 4 shows a signaling diagram of a procedure involving an NWDAF(AnLF), an NRF, an NWDAF(MTLF), and an ADRF, according to some embodiments of the present disclosure.

FIG. 5 shows an exemplary method (e.g., procedure) for a consumer NF of a communication network, according to various embodiments of the present disclosure.

FIG. 6 shows an exemplary method (e.g., procedure) for a producer NF of a communication network, according to various embodiments of the present disclosure.

FIG. 7 shows an exemplary method (e.g., procedure) for an NRF of a communication network, according to various embodiments of the present disclosure.

FIG. 8 shows an exemplary method (e.g., procedure) for an ADRF of a communication network, according to various embodiments of the present disclosure.

FIG. 9 shows a communication system according to various embodiments of the present disclosure.

FIG. 10 shows a UE according to various embodiments of the present disclosure.

FIG. 11 shows a network node according to various embodiments of the present disclosure.

FIG. 12 shows host computing system according to various embodiments of the present disclosure.

FIG. 13 is a block diagram of a virtualization environment in which functions implemented by some embodiments of the present disclosure may be virtualized.

FIG. 14 illustrates communication between a host computing system, a network node, and a UE via multiple connections, according to various embodiments of the present disclosure.

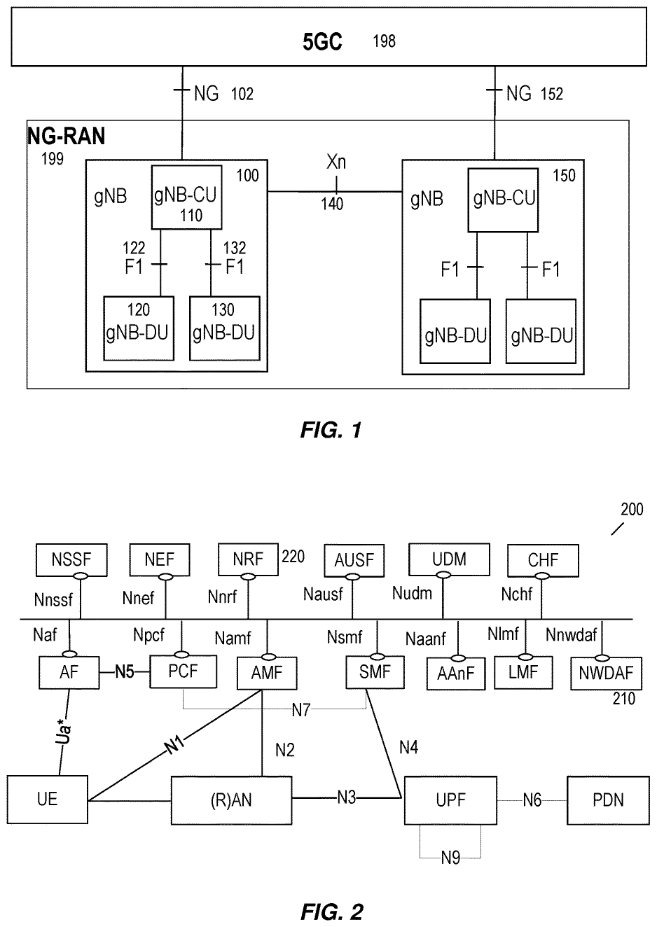

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is generally used. However, the concepts disclosed herein are not limited to a 3GPP system, and can be applied in any system that can benefit from the concepts, principles, and/or embodiments described herein.

FIG. 2 shows an exemplary non-roaming reference architecture for a 5GC (200 ), with service-based interfaces and various 3GPP-defined NFs within the Control Plane (CP). These include the following:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the NI reference point and with the RAN (e.g., NG-RAN) via the N2 reference point.
Network Exposure Function (NEF) with Nnef interface-acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF, 220) with Nnrf interface-provides service registration and discovery, enabling NFs to identify appropriate services available from other NFs.
Network Slice Selection Function (NSSF) with Nnssf interface-a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface-based in a user's home network (HPLMN), it performs user authentication and computes security key materials for various purposes.
Network Data Analytics Function (NWDAF, 210) with Nnwdaf interface, described in more detail above and below.
Location Management Function (LMF) with NImf interface-supports various functions related to determination of UE locations, including location determination for a UE and obtaining any of the following: DL location measurements or a location estimate from the UE; UL location measurements from the NG RAN; and non-UE associated assistance data from the NG RAN.

Unified Data Management (UDM) function supports generation of 3GPP authentication credentials, user identification handling, access authorization based on subscription data, and other subscriber-related functions. To provide this functionality, UDM uses subscription data (including authentication data) stored in the 5GC unified data repository (UDR). UDR supports storage and retrieval of policy data by the PCF, as well as storage and retrieval of application data by NEF.

NRF allows every NF to discover the services offered by other NFs, and Data Storage Functions (DSF) allow every NF to store its context. In addition, NEF provides exposure of capabilities and events of the 5GC to AFs within and outside of the 5GC. For example, NEF provides a service that allows an AF to provision specific subscription data (e.g., expected UE behavior) for various UEs.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (NI interface in FIG. 2). Security for the communications over this these strata is provided by the NAS protocol (for NAS) and the PDCP protocol (for AS).

3 GPP Rel-17 enhances the SBA by adding a Data Management Framework that includes a Data Collection Coordination Function (DCCF) and a Messaging Framework Adaptor Function (MFAF), which are defined in detail in 3GPP TR 23.700-91 (v17.0.0). The Data Management Framework is backward compatible with a Rel-16 NWDAF function, described above. For Rel-17, the baseline for services offered by the DCCF (e.g., to an NWDAF) are the Rel-16 NF Services used to obtain data. For example, the baseline for the DCCF service used by an NWDAF consumer to obtain UE mobility data is Namf_EventExposure.

3GPP TS 23.288 (v17.2.0) specifies that NWDAF is the main network function for computing analytics reports. The 5G system architecture allows any NF to obtain analytics from an NWDAF using a DCCF function and associated Ndccf services. The NWDAF can also store and retrieve analytics information from an Analytics Data Repository Function (ADRF).

3GPP TS 23.288 also classifies NWDAF into two sub-functions (or logical functions): NWDAF Analytics Logical Function (NWDAF AnLF), which performs analytics procedures; and NWDAF Model Training Logical Function (NWDAF MTLF), which performs training and retraining of ML models used by NWDAF AnLF. In the following, the terms “AnLF”, “NWDAF AnLF”, and “NWDAF (AnLF)” will be used interchangeably. Likewise, the terms “MTLF”, “NWDAF MTLF”, and “NWDAF (MTLF)” will be used interchangeably.

3GPP TS 23.288 (v17.2.0) specifies a subscribe/notify procedure for a consumer NF to retrieve ML model(s) associated with one or more Analytics IDs whenever a new ML model has been trained by the NWDAF MTLF and becomes available. This is referred to as ML Model Provisioning and is implemented by the Nnwdaf_MLModelProvision service.

3GPP TR 33.738 (v0.2.0) describes a study on security aspects of enablers for network automation for 5G. One of the objectives of the study is security for AI/ML model sharing and storage, which is identified as “Key Issue #3”. The following text from 3GPP TR 33.378 describes various aspects of this issue. In this text, “NFc” refers to a consumer NF and “NFp” refers to a producer NF, from the perspective of an AI/ML of interest.

### Begin 3GPP Text

### 5.3.1 Issue Details

AI/ML model is shared among NWDAFs and/or NFs (i.e., NWDAF to NWDAF, ADRF to NWDAF . . . ). In different scenarios, the NF producer of AI/ML model can store that model in ADRF, NWDAF or other entity.
ADRF (Analytical Data Repository Function) is being enhanced to store AI/ML models to facilitate the distribution and sharing of those models amongst NFs. Since AI/ML models and their algorithms are generally proprietary (i.e., subject to intellectual property rights of the designer), it is imperative to ensure that only the NFs which have been indeed provided with access authorization to the AI/ML models can read and use those models. Moreover, the ADRF itself cannot be considered as a fully trusted entity storing the sensitive AI/ML data models. Those models are indeed exposed at rest in ADRF.
The current authorization scheme defined by 3GPP for SBA works only at service level or resource/operation-level scope. This authorization granularity may be not sufficient in the AI/ML model sharing scenario, since the ADRF (Analytical Data Repository Function) or NWDAF, or any other network function which may store the AI/ML model, cannot verify whether the NF consumer is authorized to retrieve the AI/ML model.

### 5.3.2 Security Threats

An unauthorized NFc, in principle which is not eligible to retrieve a particular model stored by a NFp, could have access to the storage entity and retrieve the model.
If there is no protection against accessing and reading an AI/ML model from the ADRF stored by NFp, a compromised ADRF may expose algorithms and sensitive data to a non-authorized entity which can easily misuse it and/or distributed further to other entities, causing a bigger data security breach.

### 5.3.3 Potential Security Requirements

AI/ML models shall be protected between the entity which produces the ML model or stores the ML model in ADRF (e.g., NWDAF containing MTLF, NFp) and the entity which consumes the model (NFc).
ADRF (Analytical Data Repository Function), or any other network function which may store the AI/ML model, shall be able to authorize the NFc to retrieve that AI/ML model.
NF Service consumers shall be authorized to access to the AI/ML models in the ADRF (or any other NF which may store the ML model, for instance NWDAF MTLF).

### End 3GPP Text

3GPP TR 33.738 also describes a solution for authorization and authentication of AI/ML model transfer, which is identified as “solution #2”. This security solution protects an AI/ML model between a first entity (e.g., NF) that produces the AI/ML model (or stores the AI/ML model in ADRF) and a second entity that consumes the model (NFc). In this solution, an authorization token is used by ADRF to verify that the NFc is allowed to access the ML model.

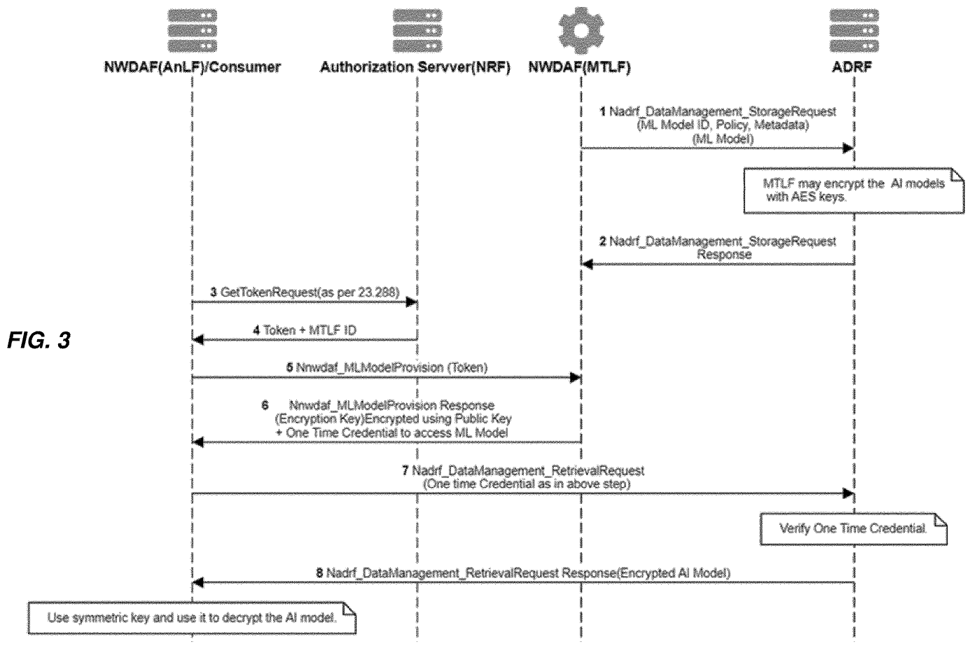

FIG. 3 shows a signaling diagram for this solution for authorization and authentication of AI/ML model transfer. As shown in FIG. 3, the signaling is between an NWDAF(AnLF)/NFc, an authorization server (e.g., NRF), an NWDAF(MTLF), and an ADRF. Although the operations shown in FIG. 3 are given numerical labels, this is intended to facilitate explanation rather than to require or imply any specific operational order, unless stated otherwise below.

In operation 1, the MTLF trains the ML model and sends ML Model to the ADRF by invoking the Nadrf_DataManagement_StorageRequest (ML Model) service operation. In addition to model metadata, this message can include ML model ID, analytics ID, Vendor ID, MAC or SHA256 Signature of the application binary, environment required for ML model execution, URL/link to retrieve configuration, and secrets/signing key/certificate to generate authentication credentials. MTLF may send an ML model encrypted using a symmetric key (e.g., AES key) before the storage.

In operation 2, ADRF stores the ML model and response as specified in 3GPP TS 23.288 (v17.6.0), except that the storage is performed by the ADRF. In operation 3, the NFc (e.g., NWDAF AnLF) contacts NRF and requests an access token using existing procedures specified in 3GPP TS 33.501 (v17.7.0). In operation 4, NRF sends an access token along with MTLF ID using existing procedures specified in 3GPP TS 23.288.

In operation 5, NWDAF(AnLF) uses Nnwdaf_MLModelProvision service operation with the access token to request the ML model ID from NWDAF(MTLF), which retrieves the ML model ID based on ML analytics ID and/or ADRF ID. NWDAF(MTLF) also verifies received access token. In operation 6, NWDAF(MTLF) sends Nnwdaf_MLModelProvision Response that includes the encryption key used to encrypt the AI/ML model in operation 1. Additionally, the NWDAF(MTLF) can include one-time credentials to access the model from ADRF, including any of the following:
Nonce, which is shared in operation 1 as part of the metadata;
MAC or hash of a binary or random number shared in operation 1 as part of the data;
signing key as a private key of MTLF, with the public part being shared in operation 1;
credentials generated by MTLF's signing key, e.g., a JWT token or a certificate.

One-time credentials can be used to limit the number of accesses from the NFc. Even so, a “one-time” credential may be used as a regular authorization token for accessing the ML model multiple times, i.e., not only once, as the name suggests.

In operation 7, NWDAF(AnLF) uses the ADRF service procedure to request the ML model, including the one-time credential received in operation 6. In operation 8, ADRF verifies the one-time credential and, if successfully verified, provides the stored AI/ML model to the NWDAF(AnLF).

As mentioned above, AI/ML models are considered important intellectual property of their owners (e.g., 5GC vendors) and, as such, must have their confidentiality and integrity protected at all times. 3GPP is studying the feasibility of sharing or storing AI/ML models in network equipment that may be provided by different vendors. In this arrangement, an AI/ML model should be protected from access and use by consumer NFs that are provided by different vendors than the AI/ML model. Currently, however, there are no specified solutions to this requirement. For example, the solution shown in FIG. 3 does not provided the needed security in a multi-vendor network environment.

Embodiments of the present disclosure address these and other problems, issues, and/or difficulties by providing secure AI/ML model sharing between NFp (e.g., NWDAF MTLF) and NFc (e.g., NWDAF AnLF) and AI/ML model storage in ADRF. For example, the NFp (e.g., NWDAF MTLF) can authorize NFc access to AI/ML models that the NFp stores locally, while ADRF can authorize NFc access to NFp's AI/ML models that it stores, based on NFp instructions.

In various embodiments, the NFp (e.g., NWDAF MTLF) can authorize transfer to, storage in, and retrieval from ADRF of an AI/ML model that it owns or controls. Also, in various embodiments, the NFp can authorize transfer of an AI/ML model that it owns or controls to an NFc (e.g., NWDAF AnLF) that requests the AI/ML model. Also, in various embodiments, the NFp can encrypt and/or integrity-protect the AI/ML model for security during any of these transfer scenarios. Various techniques are described according to these embodiments.

Embodiments of the present disclosure can provide various benefits and/or advantages. By providing the AI/ML model owner/producer the capability to protect the AI/ML model during various transfer, storage, and retrieval scenarios, embodiments can improve the security of confidential and/or sensitive AI/ML models and thereby facilitate deployment of such models in a multi-vendor communication network, such as 5GC.

In the following descriptions of various embodiments, the terms NFp and NWDAF(MTLF) may be used interchangeably, and the terms NFc and NWDAF(AnLF) may be used interchangeably. Similarly, the terms “model,” “ML model,” and “AI/ML model” may be used interchangeably.

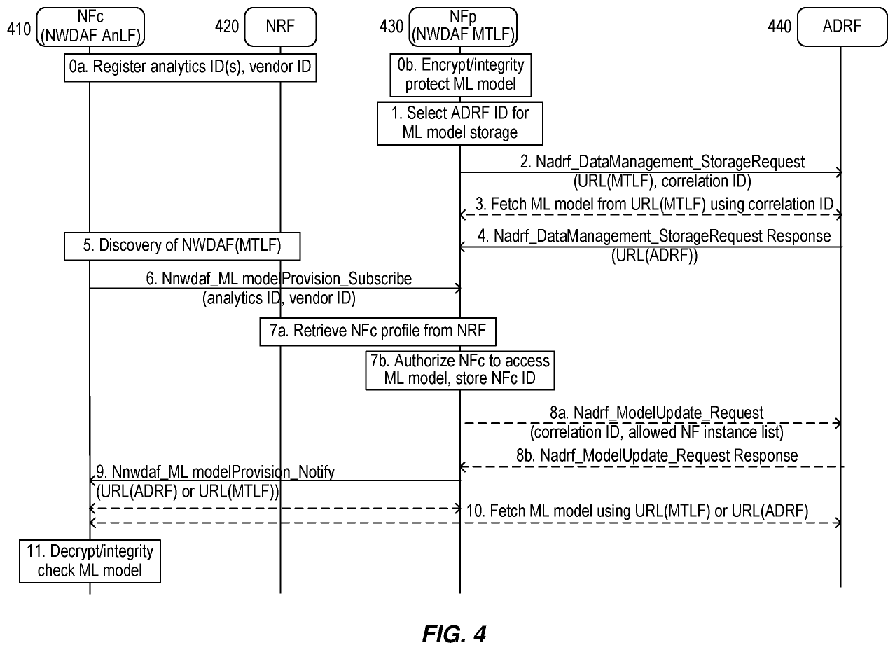

FIG. 4 shows a signaling diagram of a procedure involving an NWDAF(AnLF) 410, an NRF 420, an NWDAF(MTLF) 430, and an ADRF 440, according to some embodiments of the present disclosure. Although the operations shown in FIG. 4 are given numerical labels, this is intended to facilitate explanation rather than to require or imply any specific operational order, unless stated otherwise below.

In operation 0a, NWDAF(AnLF) registers its associated vendor ID and its supported analytic ID(s) in its NF profile in NRF. In operation 0b, NWDAF(MTLF) trains the ML model and may encrypt and/or integrity-protect it. The security algorithms and keys used for this operation can be vendor-specific and/or outside the scope of 3GPP specification.

In operation 1, NWDAF(MTLF) determines that the ML model can/should be stored in ADRF and discovers a particular ADRF instance to perform the model storage. NWDAF(MTLF) stores an identifier associated with the selected instance (referred to as ADRF ID) for later use (described below). In some variants, NWDAF(MFLT) may also store a vendor ID and/or an NFset associated with the selected instance for later use.

In operation 2, NWDAF(MTLF) invokes an Nadrf_DataManagement_StorageRequest service operation towards the selected ADRF, and includes a URL associated with the MTLF from which the ML model can be obtained. In some variants, URL(MTLF) can be a one-time-use URL. The NWDAF(MTLF) may also include a correlation ID associated with the ML model, which may also be referred to as a model ID.

In operation 3, ADRF securely fetches the protected ML model from NWDAF(MTLF) using URL(MTLF) received in operation 2. During this procedure, NWDAF(MTLF) verifies that the fetching ADRF instance is the ADRF instance selected in operation 1, based on a match or correspondence with the stored ADRF ID. In some variants, when there is no match or correspondence with ADRF ID but the NWDAF(MTLF) stored NFset, NF type, or Vendor ID associated with the selected ADRF instance, the NWDAF(MTLF) may verify that the fetching ADRF instance is in the same NFset, NF type, or Vendor ID as the selected ADRF instance. Additionally, during the fetching procedure, NWDAF(MTLF) also verifies the correlation ID provided by the fetching ADRF is associated with the ML model.

In operation 4, after storing the fetched ML model, the ADRF responds to NWDAF(MTLF) by sending an URL associated with the ADRF, from which the ML model can be obtained by NWDAF(MTLF) or other NFs.

In operation 5, NWDAF(AnLF) discovers the NWDAF(MTLF) via NRF, using existing procedures specified in 3GPP TS 23.288. In operation 6, NWDAF(AnLF) invokes Nnwdaf_MLModelProvision_Subscribe (or Nnwdaf_MLModelInfo_Request) service operation towards NWDAF(MTLF) to retrieve the ML model. NWDAF(AnLF) includes its vendor ID and one of its supported analytics ID, both of which were previously registered in operation 0a.

In operation 7a, NWDAF(MTLF) retrieves the NF profile of the requesting NWDAF(AnLF) from NRF. In operation 7b, NWDAF(MTLF) obtains the vendor ID from the NF profile and verifies that it matches the vendor ID received in operation 6. In some embodiments, the NWDAF(MTLF) may maintain an interoperability indicator (or ID), which indicates which NWDAF vendors (e.g., a list) are allowed to retrieve an ML model from NWDAF(MTLF). In such case, the NWDAF(MTLF) can also verify that the vendor ID received in operation 6 is among the vendors associated with the interoperability ID for the ML model being requested. Alternatively, NWDAF(MTLF) can verify the vendor ID received from NWDAF(AnLF) based on an authentication procedure, e.g., using certificates, tokens, etc.

If verification is successful, NWDAF(MTLF) authorizes NWDAF(AnLF) to access the ML model for the requested analytics ID. Additionally, the NWDAF(MTLF) can store an identifier of the NWDAF(AnLF), called NFc ID, in an allowed NF instance list for the ML model. In some variants, the NWDAF(MTLF) can store an NF type (e.g., AnLF), NFset, and/or vendor ID associated with the authorized NWDAF(AnLF) in the allowed NF instance list.

If the ML model is stored in ADRF, in operation 8 NWDAF(MTLF) invokes an Nadrf_ModelUpdate_Request service operation towards ADRF and includes the correlation ID and the allowed NF instance list (as updated in operation 7b). After storing the allowed NF instance list for the ML model associated with correlation ID, the ADRF responds to the NWDAF(MTLF) indicating completion of the request. In some variants, the NWDAF(MTLF) can send an NF type (e.g., AnLF), NFset, and/or vendor ID associated with the authorized NWDAF(AnLF) in the allowed NF instance list.

In operation 9, NWDAF(MTLF) responds to NWDAF(AnLF) with an Nnwdaf MLModelProvision Notify (or Nnwdaf_ MLModelInfo_Request Response) service operation. If NWDAF(MTLF) stores the ML model locally, it includes URL(MTLF) from which the ML model can be obtained (e.g., in a similar manner as ADRF in operation 3). If the ML model is stored in ADRF, the NWDAF(MTLF) includes URL(ADRF) that it received in operation 4.

In operation 10, the NWDAF(AnLF) fetches the ML model from NWDAF(MTLF) or ADRF using URL(MTLF) or URL(ADRF), respectively, received in operation 9. If the fetching is from NWDAF(MTLF), that NF verifies that the fetching NWDAF(AnLF) is the same instances whose NFc ID was added to the allowed NF instance list in operation 7b. If the fetching is from ADRF, that NF verifies that the fetching NWDAF(AnLF) is part of the allowed NF instance list received in operation 8. The fetching is authorized and proceeds if the verification by NWDAF(MTLF) or ADRF is successful. In some variants, when there is no match or correspondence with NFc ID but the receiving NF stored NFset, NF type, or Vendor ID associated with the authorized NWDAF(AnLF), the receiving NF may verify that the fetching NWDAF(AnLF) instance is in the same NFset, NF type, or Vendor ID as the authorized NWDAF(AnLF).

In operation 11, NWDAF(AnLF) performs various security operations on the retrieved ML model, such as decryption and integrity checking. These security operations can be based on corresponding security operations performed by the NWDAF(MTLF) in operation 0b. The security algorithms and keys used for this operation can be vendor-specific and/or outside the scope of 3GPP specification.

Although embodiments have been described above in the specific context of an NWDAF and its logical functions MTLF and AnLF, skilled persons will understand that underlying principles of the above-described embodiments are equally applicable to other NFs, logical functions, nodes, etc. (e.g., with different names) that perform similar operations as these respective entities.

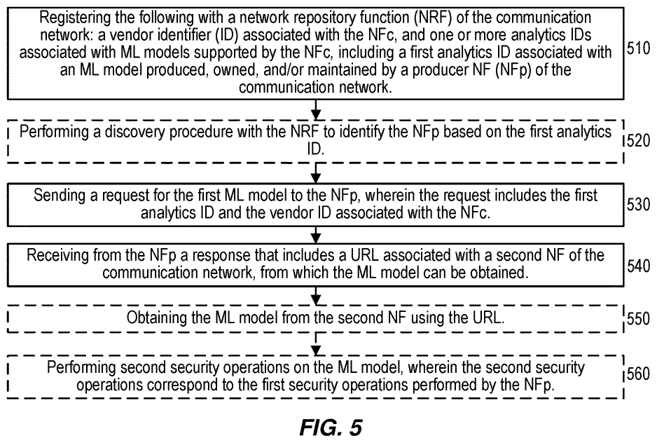

These embodiments described above can be further illustrated with reference to FIGS. 5-8, which depict exemplary methods (e.g., procedures) for a consumer NF, a producer NF, an NRF, and an ADRF, respectively. Put differently, various features of the operations described below correspond to various embodiments described above. The exemplary methods shown in FIGS. 5-8 can be used cooperatively (e.g., with each other and with other procedures described herein) to provide benefits, advantages, and/or solutions to problems described herein. Although the exemplary methods are illustrated in FIGS. 5-8 by specific blocks in particular orders, the operations corresponding to the blocks can be performed in different orders than shown and can be combined and/or divided into blocks and/or operations having different functionality than shown. Optional blocks and/or operations are indicated by dashed lines.

More specifically, FIG. 5 illustrates an exemplary method (e.g., procedure) for a consumer NF (NFc) of a communication network (e.g., 5GC), according to various embodiments of the present disclosure. The exemplary method shown in FIG. 5 can be performed by an NFc such as an NWDAF(AnLF) or by network equipment configured to implement an NWDAF(AnLF), such as described elsewhere herein.

The exemplary method includes the operations of block 510, where the NFc registers the following information with an NRF of the communication network: a vendor identifier (ID) associated with the NFc, and one or more analytics IDs associated with ML models supported by the NFc, including a first analytics ID associated with a first ML model produced, owned, and/or maintained by an NFp of the communication network. The exemplary method includes the operations of block 530, where the NFc sends a request for the first ML model to the NFp. The request includes the first analytics ID and the vendor ID associated with the NFc. The exemplary method includes the operations of block 540, where the NFc receives from the NFp a response that includes a URL associated with a second NF of the communication network, from which the ML model can be obtained.

In some embodiments, the NFc is an NWDAF(AnLF) and/or the NFp is an NWDAF(MTLF).

In some embodiments, the exemplary method also includes the operations of block 550, where the NFc obtains the ML model from the second NF using the URL. In some embodiments, the second NF associated with the URL is one of the following: the NFp, or an ADRF of the communication network.

In some embodiments, the exemplary method also includes the operations of block 560, where the NFc performs second security operations on the ML model. The second security operations correspond to first security operations performed on the ML model by the NFp. In some of these embodiments, the first security operations include encryption and/or integrity protection and the second security operations include decryption corresponding to the encryption and/or integrity checking corresponding to the integrity protection.

In some embodiments, the response from the NFp is based on a match, correspondence, or relationship between the vendor ID registered with the NRF and the vendor ID included in the request. In some embodiments, the exemplary method also includes the operations of block 520, where the NFc performs a discovery procedure with the NRF to identify the NFp based on the first analytics ID. In such case, the request is sent (e.g., in block 530) responsive to the discovery procedure.

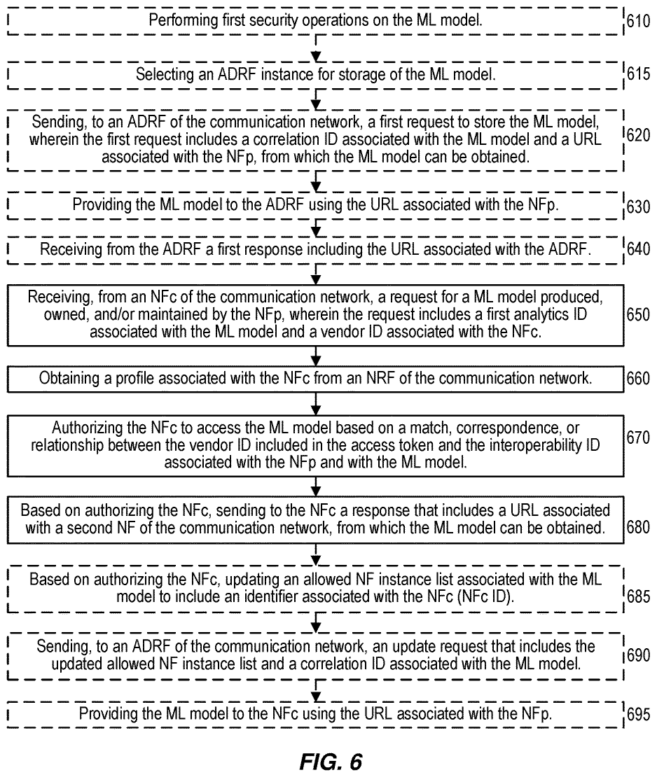

In addition, FIG. 6 illustrates an exemplary method (e.g., procedure) for an NFp of a communication network (e.g., 5GC), according to various embodiments of the present disclosure. The exemplary method shown in FIG. 6 can be performed by an NFp such as an NWDAF (MTLF) or by network equipment configured to implement an NWDAF (MTLF), such as described elsewhere herein.

The exemplary method includes the operations of block 650, where the NFp receives, from an NFc of the communication network, a request for an ML model produced, owned, and/or maintained by the NFp. The request includes a first analytics ID associated with the ML model and a vendor ID associated with the NFc. The exemplary method includes the operations of block 660, where the NFp obtains a profile associated with the NFc from an NRF of the communication network. The exemplary method includes the operations of block 670, where the NFp authorizes the NFc to access the ML model based on a match, correspondence, or relationship between a vendor ID included in the retrieved NF profile and the vendor ID included in the request. The exemplary method includes the operations of block 680, where based on authorizing the NFc, the NFp sends to the NFc a response that includes a URL associated with a second NF of the communication network, from which the ML model can be obtained.

In some embodiments, the NFc is an NWDAF(AnLF) and/or the NFp is an NWDAF(MTLF).

In some embodiments, authorizing the NFC to access the ML model in block 670 is further based on a match, correspondence, or relationship between the vendor ID included in the request and an interoperability ID associated with the NFp and with the ML model.

In some embodiments, the exemplary method also includes the operations of block 685, where based on authorizing the NFc (e.g., in block 680), the NFp updates an allowed NF instance list associated with the ML model to include an identifier associated with the NFc (NFc ID). In some of these embodiments, the exemplary method also includes the operations of block 690, where the NFp sends, to an ADRF of the communication network, an update request that includes the updated allowed NF instance list and a correlation ID associated with the ML model.

In some embodiments, the second NF associated with the URL is the NFp, and the exemplary method also includes the operations of block 695, where the NFp subsequently provides the ML model to the NFc using the URL associated with the NFp. For example, the NFp can facilitate the NFc's fetch of the ML model using the URL associated with the NFp. In some of these embodiments, providing the ML model to the NFc in block 695 is based on a match, correspondence, or relationship between an identifier associated with the NFc and an allowed NF instance list associated with the ML model (e.g., updated according to block 685).

In other embodiments, the second NF associated with the URL is an ADRF of the communication network, and the exemplary method also includes the following operations, labelled with corresponding block numbers:
(620) sending to the ADRF a first request to store the ML model, wherein the first request includes a correlation ID associated with the ML model and a URL associated with the NFp, from which the ML model can be obtained;
(630) providing the ML model to the ADRF using the URL associated with the NFp; and
(640) receiving from the ADRF a first response including the URL associated with the ADRF, which is sent to the NFc in the response.

In some of these embodiments, the exemplary method also includes the operations of block 615, where the NFp selects an ADRF instance for storage of the ML model, where the ADRF instance is associated with an ADRF ID. In such case, the first request is sent in block 620 to the ADRF instance and providing the ML model to the ADRF in block 695 is based on a match, correspondence, or relationship between the ADRF ID and the ADRF to which the ML model is provided.

In some embodiments, the exemplary method also includes the operations of block 610, where the NFp performs first security operations on the ML model. The first security operations include encryption and/or integrity protection.

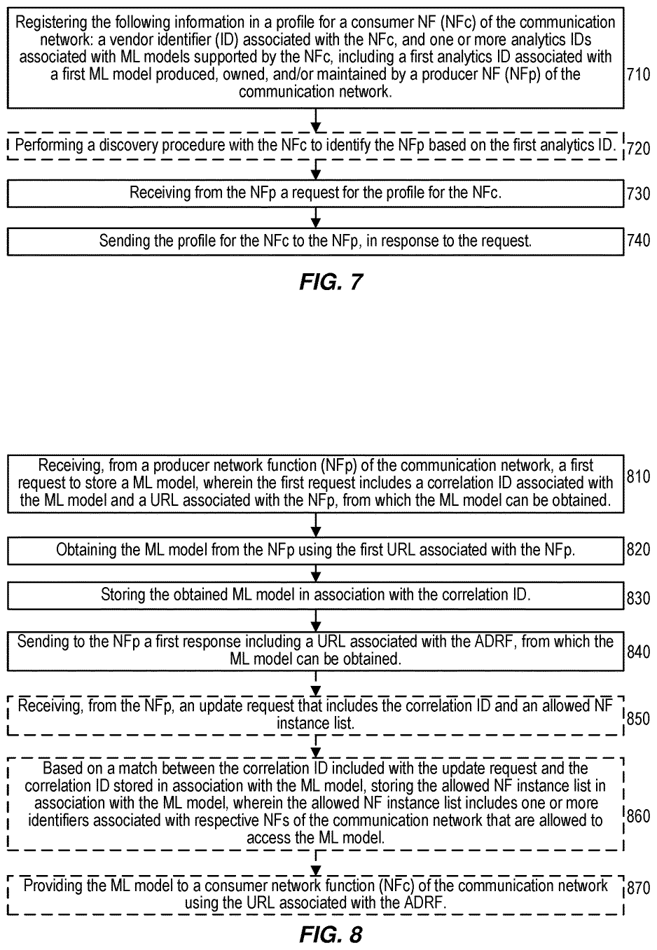

In addition, FIG. 7 illustrates an exemplary method (e.g., procedure) for an NRF of a communication network (e.g., 5GC), according to various embodiments of the present disclosure. The exemplary method shown in FIG. 7 can be performed by an NRF or by network equipment configured to implement an NRF, such as described elsewhere herein.

The exemplary method includes the operations of block 710, where the NRF registers the following information in a profile for a consumer NF (NFc) of the communication network: a vendor identifier (ID) associated with the NFc, and one or more analytics IDs associated with ML models supported by the NFc, including a first analytics ID associated with a first ML model produced, owned, and/or maintained by an NFp of the communication network. The exemplary method also includes the operations of blocks 730-740, where the NFp receives from the NFp a request for the profile for the NFc and sends the profile for the NFc to the NFp, in response to the request.

In some embodiments, the exemplary method also includes the operations of block 720, where the NRF performs a discovery procedure with the NFc to identify the NFp based on the first analytics ID.

In some embodiments, the NFc is an NWDAF (AnLF). In some embodiments, the NFp is an NWDAF (MTLF).

In addition, FIG. 8 illustrates an exemplary method (e.g., procedure) for an ADRF of a communication network (e.g., 5GC), according to various embodiments of the present disclosure. The exemplary method shown in FIG. 8 can be performed by an ADRF or by network equipment configured to implement an ADRF, such as described elsewhere herein.

The exemplary method includes the operations of block 810, where the ADRF receives, from an NFp of the communication network, a first request to store an ML model. The first request includes a correlation ID associated with the ML model and a URL associated with the NFp, from which the ML model can be obtained. The exemplary method also includes the operations of block 820, where the ADRF obtains the ML model from the NFp using the URL associated with the NFp. In some embodiments, the obtained ML model can be encrypted and/or integrity protected. The exemplary method also includes the operations of blocks 830-840, where the ADRF stores the obtained ML model in association with the correlation ID and sends to the NFp a first response including a URL associated with the ADRF, from which the ML model can be obtained.

In some embodiments, the exemplary method also includes the operations of block 850, where the ADRF receives from the NFp an update request that includes the correlation ID and an allowed NF instance list. The exemplary method also include the operations of block 860, where based on a match between the correlation ID included with the update request and the correlation ID stored in association with the ML model, the ADRF stores the allowed NF instance list in association with the ML model. In particular, the allowed NF instance list includes one or more identifiers associated with respective NFs of the communication network that are allowed (e.g., authorized) to access the ML model.

In some of these embodiments, the exemplary method also includes the operations of block 870, where the ADRF provides the ML model to an NFc of the communication network using the URL associated with the ADRF. For example, the ADRF can facilitate the NFc's fetch of the ML model using the URL associated with the ADRF. In some of these embodiments, providing the ML model to the NFc in block 870 is based on a match, correspondence, or relationship between an identifier associated with the NFc and an identifier included in an allowed NF instance list stored in association with the ML model (e.g., in block 860). In some of these embodiments, the NFc is an NWDAF(AnLF). In some of these embodiments, the NFp is an NWDAF(MTLF).

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

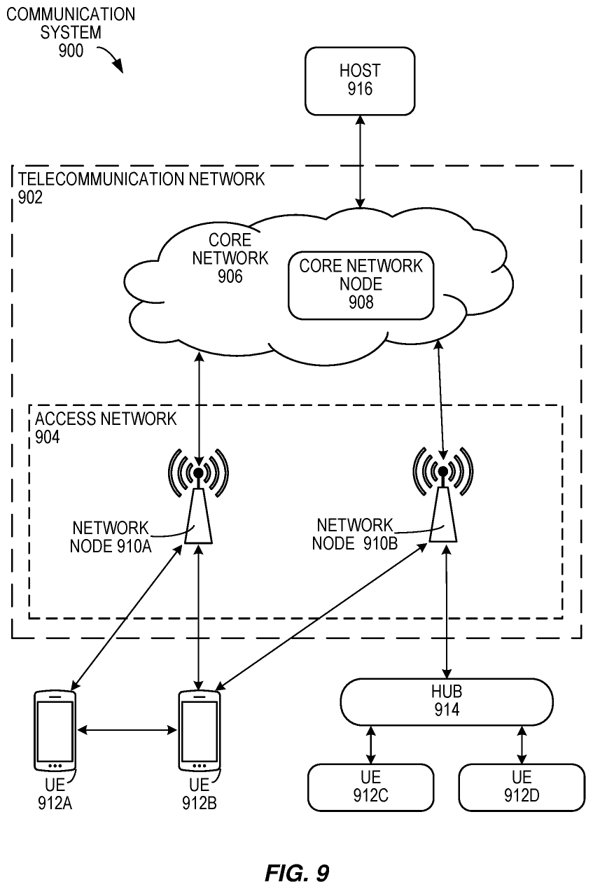

FIG. 9 shows an example of a communication system 900 in accordance with some embodiments. In this example, communication system 900 includes telecommunication network 902 that includes an access network 904 (e.g., RAN) and a core network 906, which includes one or more core network nodes 908. Access network 904 includes one or more access network nodes, such as network nodes 910a-b (one or more of which may be generally referred to as network nodes 910), or any other similar 3GP) access node or non-3GPP access point. Network nodes 910 facilitate direct or indirect connection of UEs, such as by connecting UEs 912a-d (one or more of which may be generally referred to as UEs 912) to core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 900 may include any number of wired or wireless networks, network nodes, UEs, and/or any other components or systems that may facilitate or participate in the communication of data and/or signals whether via wired or wireless connections. Communication system 900 may include and/or interface with any type of communication, telecommunication, data, cellular, radio network, and/or other similar type of system.

UEs 912 may be any of a wide variety of communication devices, including wireless devices arranged, configured, and/or operable to communicate wirelessly with network nodes 910 and other communication devices. Similarly, network nodes 910 are arranged, capable, configured, and/or operable to communicate directly or indirectly with UEs 912 and/or with other network nodes or equipment in telecommunication network 902 to enable and/or provide network access, such as wireless network access, and/or to perform other functions, such as administration in telecommunication network 902.

In the depicted example, core network 906 connects network nodes 910 to one or more hosts, such as host 916. These connections may be direct or indirect via one or more intermediary networks or devices. In other examples, network nodes may be directly coupled to hosts. Core network 906 includes one or more core network nodes (e.g., 908) that are structured with hardware and software components. Features of these components may be substantially similar to those described with respect to the UEs, network nodes, and/or hosts, such that the descriptions thereof are generally applicable to the corresponding components of core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 916 may be under the ownership or control of a service provider other than an operator or provider of access network 904 and/or telecommunication network 902, and may be operated by the service provider or on behalf of the service provider. Host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 902 is a cellular network that implements 3GPP standardized features. Accordingly, telecommunication network 902 may support network slicing to provide different logical networks to different devices that are connected to telecommunication network 902. For example, telecommunication network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 912 are configured to transmit and/or receive information without direct human interaction. For instance, a UE may be designed to transmit information to access network 904 on a predetermined schedule, when triggered by an internal or external event, or in response to requests from access network 904. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 914 communicates with access network 904 to facilitate indirect communication between one or more UEs (e.g., UE 912c and/or 912d) and network nodes (e.g., network node 910b). In some examples, hub 914 may be a controller, router, content source and analytics, or any of the other communication devices described herein regarding UEs. For example, hub 914 may be a broadband router enabling access to core network 906 for the UEs. As another example, hub 914 may be a controller that sends commands or instructions to one or more actuators in the UEs. Commands or instructions may be received from the UEs, network nodes 910, or by executable code, script, process, or other instructions in hub 914. As another example, hub 914 may be a data collector that acts as temporary storage for UE data and, in some embodiments, may perform analysis or other processing of the data. As another example, hub 914 may be a content source. For example, for a UE that is a VR headset, display, loudspeaker or other media delivery device, hub 914 may retrieve VR assets, video, audio, or other media or data related to sensory information via a network node, which hub 914 then provides to the UE either directly, after performing local processing, and/or after adding additional local content. In still another example, hub 914 acts as a proxy server or orchestrator for the UEs, in particular in if one or more of the UEs are low energy IoT devices.

Hub 914 may have a constant/persistent or intermittent connection to network node 910b. Hub 914 may also allow for a different communication scheme and/or schedule between hub 914 and UEs (e.g., UE 912c and/or 912d), and between hub 914 and core network 906. In other examples, hub 914 is connected to core network 906 and/or one or more UEs via a wired connection. Moreover, hub 914 may be configured to connect to an M2M service provider over access network 904 and/or to another UE over a direct connection. In some scenarios, UEs may establish a wireless connection with network nodes 910 while still connected via hub 914 via a wired or wireless connection. In some embodiments, hub 914 may be a dedicated hub—that is, a hub whose primary function is to route communications to/from the UEs from/to network node 910b. In other embodiments, hub 914 may be a non-dedicated hub-that is, a device which is capable of operating to route communications between the UEs and network node 910b, but which is additionally capable of operating as a communication start and/or end point for certain data channels.

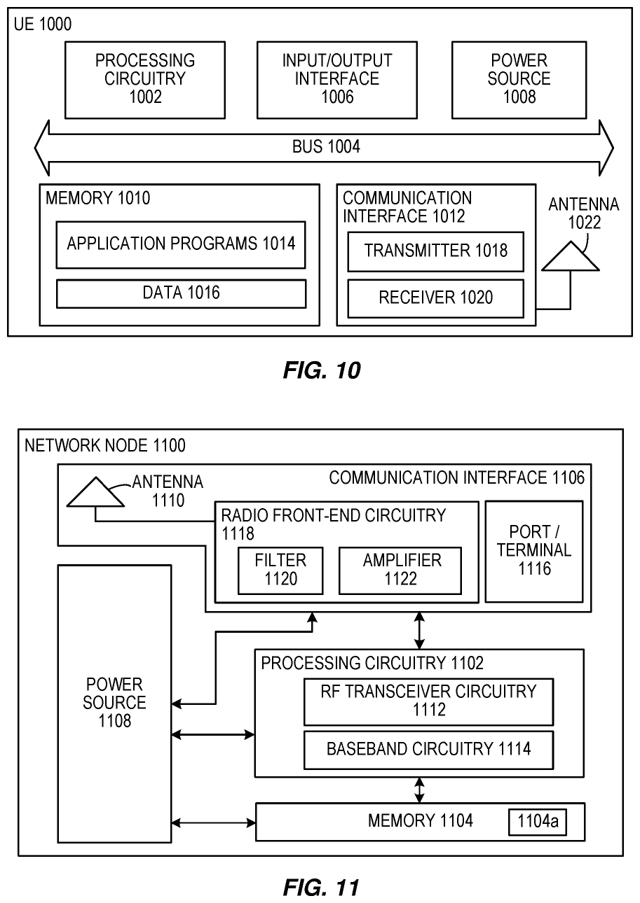

FIG. 10 shows a UE 1000 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1000 includes processing circuitry 1002 that is operatively coupled via bus 1004 to input/output interface 1006, power source 1008, memory 1010, communication interface 1012, and possibly other components not explicitly shown. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

Processing circuitry 1002 is configured to process instructions and data and may be configured to implement any sequential state machine operative to execute instructions stored as machine-readable computer programs in memory 1010. Processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1002 may include multiple central processing units (CPUs).

In the example, input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1008 is structured as a battery or battery pack. Other types of power sources, such as an external power source (e.g., an electricity outlet), photovoltaic device, or power cell, may be used. Power source 1008 may further include power circuitry for delivering power from power source 1008 itself, and/or an external power source, to the various parts of UE 1000 via input circuitry or an interface such as an electrical power cable. Delivering power may be, for example, for charging of power source 1008. Power circuitry may perform any formatting, converting, or other modification to the power from power source 1008 to make the power suitable for the respective components of UE 1000 to which power is supplied.

Memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1010 includes one or more application programs 1014, such as an operating system, web browser application, a widget, gadget engine, or other application, and corresponding data 1016. Memory 1010 may store, for use by UE 1000, any of a variety of various operating systems or combinations of operating systems.

Memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1010 may allow UE 1000 to access instructions, application programs and the like, stored on transitory or non-transitory memory media, to off-load data, or to upload data. An article of manufacture, such as one utilizing a communication system may be tangibly embodied as or in memory 1010, which may be or comprise a device-readable storage medium.

Processing circuitry 1002 may be configured to communicate with an access network or other network using communication interface 1012. Communication interface 1012 may comprise one or more communication subsystems and may include or be communicatively coupled to an antenna 1022. Communication interface 1012 may include one or more transceivers used to communicate, such as by communicating with one or more remote transceivers of another device capable of wireless communication (e.g., another UE or a network node in an access network). Each transceiver may include transmitter 1018 and/or a 1020 appropriate to provide network communications (e.g., optical, electrical, frequency allocations, and so forth). Moreover, transmitter 1018 and/or receiver 1020 may be coupled to one or more antennas (e.g., 1022) and may share circuit components, software, or firmware, or alternatively be implemented separately.

In the illustrated embodiment, communication functions of communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

FIG. 11 shows a network node 1100 in accordance with some embodiments. Examples of network nodes include, but are not limited to, access points (e.g., radio access points) and base stations (e.g., radio base stations, Node Bs, eNBs, gNBs, etc.).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

As a more specific example, one or more network nodes 1100 can be configured to perform operations attributed to various NFs in the descriptions herein of various methods or procedures. As a more specific example, the one or more network nodes 1100 can be configured to perform operations attributed to a consumer NF (e.g., NWDAF AnLF), a producer NF (e.g., NWDAF MTLF), an NRF, and an ADRF.

Network node 1100 includes processing circuitry 1102, memory 1104, communication interface 1106, and power source 1108. Network node 1100 may be composed of multiple physically separate components (e.g., a NodeB component and a RNC component, or a BTS component and a BSC component, etc.), which may each have their own respective components. In certain scenarios in which network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). Network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

Processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as memory 1104, to provide network node 1100 functionality.

In some embodiments, processing circuitry 1102 includes a system on a chip (SOC). In some embodiments, processing circuitry 1102 includes one or more of radio frequency (RF) transceiver circuitry 1112 and baseband processing circuitry 1114. In some embodiments, RF transceiver circuitry 1112 and baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

Memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1102. Memory 1104 may store any suitable instructions, data, or information, including a computer program, software, an application including one or more of logic, rules, code, tables, and/or other instructions (collectively denoted computer program 1104a, which may be in the form of a computer program product) capable of being executed by processing circuitry 1102 and utilized by network node 1100. Memory 1104 may be used to store any calculations made by processing circuitry 1102 and/or any data received via communication interface 1106. In some embodiments, processing circuitry 1102 and memory 1104 is integrated.

Communication interface 1106 is used in wired or wireless communication of signaling and/or data between a network node, access network, and/or UE. As illustrated, communication interface 1106 comprises port(s)/terminal(s) 1116 to send and receive data, for example to and from a network over a wired connection. Communication interface 1106 also includes radio front-end circuitry 1118 that may be coupled to, or in certain embodiments a part of, antenna 1110. Radio front-end circuitry 1118 comprises filters 1120 and amplifiers 1122. Radio front-end circuitry 1118 may be connected to an antenna 1110 and processing circuitry 1102. The radio front-end circuitry may be configured to condition signals communicated between antenna 1110 and processing circuitry 1102. Radio front-end circuitry 1118 may receive digital data that is to be sent out to other network nodes or UEs via a wireless connection. Radio front-end circuitry 1118 may convert the digital data into a radio signal having the appropriate channel and bandwidth parameters using a combination of filters 1120 and/or amplifiers 1122. The radio signal may then be transmitted via antenna 1110. Similarly, when receiving data, antenna 1110 may collect radio signals which are then converted into digital data by radio front-end circuitry 1118. The digital data may be passed to processing circuitry 1102. In other embodiments, the communication interface may comprise different components and/or different combinations of components.

In certain alternative embodiments, network node 1100 does not include separate radio front-end circuitry 1118, instead, processing circuitry 1102 includes radio front-end circuitry and is connected to antenna 1110. Similarly, in some embodiments, all or some of RF transceiver circuitry 1112 is part of communication interface 1106. In still other embodiments, communication interface 1106 includes one or more ports or terminals 1116, radio front-end circuitry 1118, and RF transceiver circuitry 1112, as part of a radio unit (not shown), and communication interface 1106 communicates with baseband processing circuitry 1114, which is part of a digital unit (not shown).

Antenna 1110 may include one or more antennas, or antenna arrays, configured to send and/or receive wireless signals. Antenna 1110 may be coupled to radio front-end circuitry 1118 and may be any type of antenna capable of transmitting and receiving data and/or signals wirelessly. In certain embodiments, antenna 1110 is separate from network node 1100 and connectable to network node 1100 through an interface or port.

Antenna 1110, communication interface 1106, and/or processing circuitry 1102 may be configured to perform any receiving operations and/or certain obtaining operations described herein as being performed by the network node. Any information, data and/or signals may be received from a UE, another network node and/or any other network equipment. Similarly, antenna 1110, communication interface 1106, and/or processing circuitry 1102 may be configured to perform any transmitting operations described herein as being performed by the network node. Any information, data and/or signals may be transmitted to a UE, another network node and/or any other network equipment.

Power source 1108 provides power to the various components of network node 1100 in a form suitable for the respective components (e.g., at a voltage and current level needed for each respective component). Power source 1108 may further comprise, or be coupled to, power management circuitry to supply the components of network node 1100 with power for performing the functionality described herein. For example, network node 1100 may be connectable to an external power source (e.g., the power grid, an electricity outlet) via an input circuitry or interface such as an electrical cable, whereby the external power source supplies power to power circuitry of power source 1108. As a further example, power source 1108 may comprise a source of power in the form of a battery or battery pack which is connected to, or integrated in, power circuitry. The battery may provide backup power should the external power source fail.

Embodiments of network node 1100 may include additional components beyond those shown in FIG. 11 for providing certain aspects of the network node's functionality, including any of the functionality described herein and/or any functionality necessary to support the subject matter described herein. For example, network node 1100 may include user interface equipment to allow input of information into network node 1100 and to allow output of information from network node 1100. This may allow a user to perform diagnostic, maintenance, repair, and other administrative functions for network node 1100.

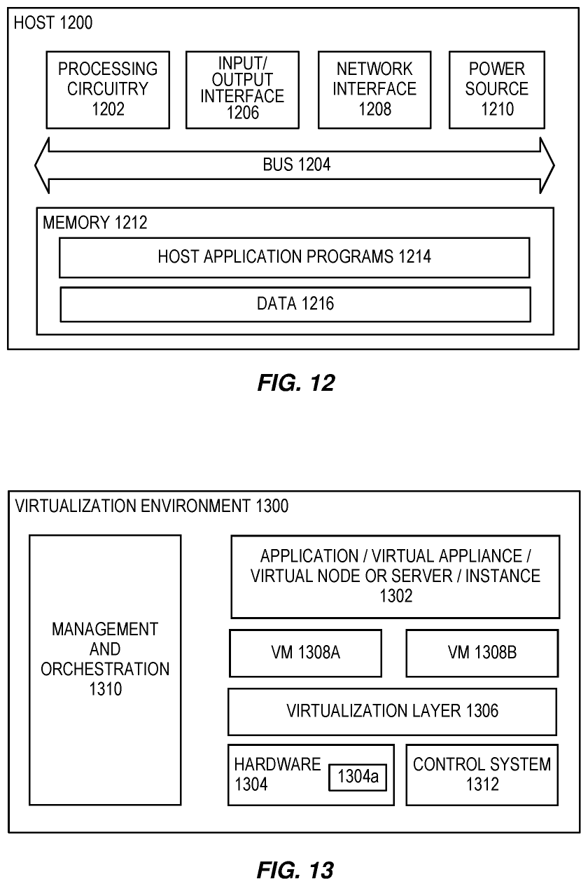

FIG. 12 is a block diagram of a host 1200, which may be an embodiment of host 916 of FIG. 9, in accordance with various aspects described herein. Host 1200 may be or comprise various combinations hardware and/or software, including a standalone server, a blade server, a cloud-implemented server, a distributed server, a virtual machine, container, or processing resources in a server farm. Host 1200 may provide one or more services to one or more UEs.

Host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

Memory 1212 may include one or more computer programs including one or more host application programs 1214 and data 1216, which may include user data, e.g., data generated by a UE for host 1200 or data generated by host 1200 for a UE. Embodiments of host 1200 may utilize only a subset or all of the components shown. Host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1214 may also provide for user authentication and licensing checks and may periodically report health, routes, and content availability to a central node, such as a device in or on the edge of a core network. Accordingly, host 1200 may select and/or indicate a different host for over-the-top services for a UE. Host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

For example, various NFs (or portions thereof) described herein in relation to other figures can be implemented as virtual network functions 1302 in virtualization environment 1300. As a more specific example, a consumer NF (e.g., NWDAF AnLF), a producer NF (e.g., NWDAF MTLF), an NRF, and/or an ADRF can be implemented as virtual network functions 1302 in virtualization environment 1300.

Hardware 1304 includes processing circuitry, memory that stores software and/or instructions (collectively denoted computer program 1304a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a-b (one or more of which may be generally referred to as VMs 1308), and/or perform any of the functions, features and/or benefits described in relation with some embodiments described herein. The virtualization layer 1306 may present a virtual operating platform that appears like networking hardware to VMs 1308.

VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1308 may be a software implementation of a physical machine that runs programs as if they were executing on a physical, non-virtualized machine. Each VM 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

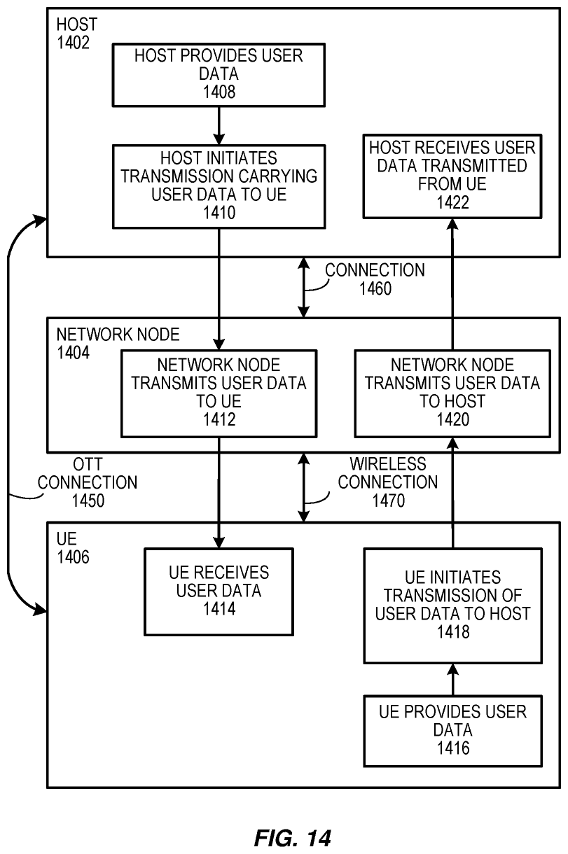

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. Host 1402 also includes software, which is stored in or accessible by host 1402 and executable by the processing circuitry. The software includes a host application that may be operable to provide a service to a remote user, such as UE 1406 connecting via an over-the-top (OTT) connection 1450 extending between UE 1406 and host 1402. In providing the service to the remote user, a host application may provide user data which is transmitted using OTT connection 1450.

Network node 1404 includes hardware enabling it to communicate with host 1402 and UE 1406. Connection 1460 may be direct or pass through a core network (like core network 906 of FIG. 9) and/or one or more other intermediate networks, such as one or more public, private, or hosted networks. For example, an intermediate network may be a backbone network or the Internet.

UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of host 1402. In host 1402, an executing host application may communicate with the executing client application via OTT connection 1450 terminating at UE 1406 and host 1402. In providing the service to the user, the UE's client application may receive request data from the host's host application and provide user data in response to the request data. OTT connection 1450 may transfer both the request data and the user data. The UE's client application may interact with the user to generate the user data that it provides to the host application through OTT connection 1450.

OTT connection 1450 may extend via a connection 1460 between host 1402 and network node 1404 and via wireless connection 1470 between network node 1404 and UE 1406 to provide the connection between host 1402 and UE 1406. Connection 1460 and wireless connection 1470, over which OTT connection 1450 may be provided, have been drawn abstractly to illustrate the communication between host 1402 and UE 1406 via network node 1404, without explicit reference to any intermediary devices and the precise routing of messages via these devices.

As an example of transmitting data via OTT connection 1450, in step 1408, host 1402 provides user data, which may be performed by executing a host application. In some embodiments, the user data is associated with a particular human user interacting with UE 1406. In other embodiments, the user data is associated with a UE 1406 that shares data with host 1402 without explicit human interaction. In step 1410, host 1402 initiates a transmission carrying the user data towards UE 1406. Host 1402 may initiate the transmission responsive to a request transmitted by UE 1406. The request may be caused by human interaction with UE 1406 or by operation of the client application executing on UE 1406. The transmission may pass via network node 1404, in accordance with the teachings of the embodiments described throughout this disclosure. Accordingly, in step 1412, network node 1404 transmits to UE 1406 the user data that was carried in the transmission that host 1402 initiated, in accordance with the teachings of the embodiments described throughout this disclosure. In step 1414, UE 1406 receives the user data carried in the transmission, which may be performed by a client application executed on UE 1406 associated with the host application executed by host 1402.

In some examples, UE 1406 executes a client application which provides user data to host 1402. The user data may be provided in reaction or response to the data received from host 1402. Accordingly, in step 1416, UE 1406 may provide user data, which may be performed by executing the client application. In providing the user data, the client application may further consider user input received from the user via an input/output interface of UE 1406. Regardless of the specific manner in which the user data was provided, UE 1406 initiates, in step 1418, transmission of the user data towards host 1402 via network node 1404. In step 1420, in accordance with the teachings of the embodiments described throughout this disclosure, network node 1404 receives user data from UE 1406 and initiates transmission of the received user data towards host 1402. In step 1422, host 1402 receives the user data carried in the transmission initiated by UE 1406.

One or more of the various embodiments improve the performance of OTT services provided to UE 1406 using OTT connection 1450, in which wireless connection 1470 forms the last segment. For example, by providing an AI/ML model owner/producer with the ability to protect the AI/ML model during various transfer, storage, and retrieval scenarios, embodiments improve the security of confidential and/or sensitive AI/ML models and thereby facilitate deployment of such models in a multi-vendor communication network, such as 5GC. In this manner, embodiments facilitate improvement of network performance based on deployed AI/ML models, and consequently increased the value of OTT services delivered over networks improved in this manner.

In an example scenario, factory status information may be collected and analyzed by host 1402. As another example, host 1402 may process audio and video data which may have been retrieved from a UE for use in creating maps. As another example, host 1402 may collect and analyze real-time data to assist in controlling vehicle congestion (e.g., controlling traffic lights). As another example, host 1402 may store surveillance video uploaded by a UE. As another example, host 1402 may store or control access to media content such as video, audio, VR or AR which it can broadcast, multicast or unicast to UEs. As other examples, host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1450 between host 1402 and UE 1406, in response to variations in the measurement results. The measurement procedure and/or the network functionality for reconfiguring the OTT connection may be implemented in software and hardware of host 1402 and/or UE 1406. In some embodiments, sensors (not shown) may be deployed in or in association with other devices through which OTT connection 1450 passes; the sensors may participate in the measurement procedure by supplying values of the monitored quantities exemplified above, or supplying values of other physical quantities from which software may compute or estimate the monitored quantities. The reconfiguring of OTT connection 1450 may include message format, retransmission settings, preferred routing etc. ; the reconfiguring need not directly alter the operation of network node 1404. Such procedures and functionalities may be known and practiced in the art. In certain embodiments, measurements may involve proprietary UE signaling that facilitates measurements of throughput, propagation times, latency, and the like, by host 1402. The measurements may be implemented in that software causes messages to be transmitted, in particular empty or ‘dummy’ messages, using OTT connection 1450 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for performing one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Example embodiments of the techniques and apparatus described herein include, but are not limited to, the following enumerated embodiments:

A1. A method for a consumer network function (NFc) of a communication network, the method comprising:
registering the following with a network repository function (NRF) of the communication network:
   a vendor identifier (ID) associated with the NFc, and
   one or more analytics IDs associated with ML models supported by the NFc, including a first analytics ID associated with an ML model produced, owned, and/or maintained by a producer NF (NFp) of the communication network;
sending a request for the ML model to the NFp, wherein the request includes the first analytics ID and the vendor ID associated with the NFc; and
receiving from the NFp a response that includes a universal resource locator (URL) associated with a second NF of the communication network, from which the ML model can be obtained.
   A2. The method of embodiment A1, further comprising obtaining the ML model from the second NF using the URL.
   A3. The method of any of embodiments A1-A2, wherein the second NF associated with the URL is one of the following: the NFp, or an analytics data repository function (ADRF) of the communication network.
   A4. The method of any of embodiments A1-A3, further comprising performing second security operations on the ML model, wherein the second security operations correspond to the first security operations performed on the ML model by the NFp.
   A5. The method of embodiment A4, wherein:
the first security operations include encryption and/or integrity protection;
the second security operations include decryption corresponding to the encryption and/or integrity checking corresponding to the integrity protection.
   A6. The method of any of embodiments A1-A5, wherein the response from the NFp is based on a match, correspondence, or relationship between the vendor ID registered with the NRF and the vendor ID included in the request.
   A7. The method of any of embodiments A1-A6, further comprising performing a discovery procedure with the NRF to identify the NFp based on the first analytics ID, wherein the request sent responsive to the discovery procedure.
   A8. The method of any of embodiments A1-A7, wherein one or more of the following applies:
the NFc is an analytics logical function of a network data analytics function, NWDAF (AnLF); and
the NFp is a model training logical function of the network data analytics function, NWDAF (MTLF).
   B1. A method for a producer network function (NFp) of a communication network, the method comprising:
receiving, from a consumer NF (NFc) of the communication network, a request for a machine learning (ML) model produced, owned, and/or maintained by the NFp, wherein the request includes a first analytics identifier (ID) associated with the ML model and a vendor ID associated with the NFc;
obtaining a profile associated with the NFc from a network repository function (NRF) of the communication network;
authorizing the NFc to access the ML model based on a match, correspondence, or relationship between a vendor ID included in the retrieved NF profile and the vendor ID included in the request; and
based on authorizing the NFc, sending to the NFc a response that includes a universal resource locator (URL) associated with a second NF of the communication network, from which the ML model can be obtained.
   B2. The method of embodiment B1, wherein authorizing the NFC to access the ML model is further based on a match, correspondence, or relationship between the vendor ID included in the request and an interoperability ID associated with the NFp and with the ML model.
   B3. The method of any of embodiments B1-B2, further comprising, based on authorizing the NFc, updating an allowed NF instance list associated with the ML model to include an identifier associated with the NFc (NFc ID).
   B4. The method of embodiment B3, further comprising sending, to an analytics data repository function (ADRF) of the communication network, an update request that includes the updated allowed NF instance list and a correlation ID associated with the ML model.
   B5. The method of any of embodiments B1-B4, wherein:
the second NF associated with the URL is the NFp; and
the method further comprises subsequently providing the ML model to the NFc using the URL associated with the NFp.
   B5a. The method of embodiment B5, wherein providing the ML model to the NFc is based on match, correspondence, or relationship between an identifier associated with the NFc and an allowed NF instance list associated with the ML model.
   B6. The method of any of embodiments B1-B4, wherein:
the second NF associated with the URL is an analytics data repository function (ADRF) of the communication network; and
the method further comprises;
   sending to the ADRF a first request to store the ML model, wherein the first request includes a correlation ID associated with the ML model and a URL associated with the NFp, from which the ML model can be obtained;
   providing the ML model to the ADRF using the URL associated with the NFp; and
   receiving from the ADRF a first response including the URL associated with the ADRF, which is sent to the NFc in the response.
      B7. The method of embodiment B6, wherein:
the method further comprises selecting an ADRF instance for storage of the ML model;
the ADRF instance is associated with an ADRF ID;
the first request is sent to the ADRF instance; and
providing the ML model to the ADRF is based on a match, correspondence, or relationship between the ADRF ID and the ADRF to which the ML model is provided.
   B8. The method of any of embodiments B1-B7, further comprising performing first security operations on the ML model, wherein the first security operations include encryption and/or integrity protection.
   B9. The method of any of embodiments B1-B8, wherein one or more of the following applies:
the NFc is an analytics logical function of a network data analytics function, NWDAF (AnLF); and
the NFp is a model training logical function of the network data analytics function, NWDAF (MTLF).
   C1. A method for a network repository function (NRF) of a communication network, the method comprising:
registering the following information in a profile for a consumer NF (NFc) of the communication network:
   a vendor identifier (ID) associated with the NFc, and
   one or more analytics IDs associated with ML models supported by the NFc, including a first analytics ID associated with a first ML model produced, owned, and/or maintained by a producer NF (NFp) of the communication network;
receiving from the NFp a request for the profile for the NFc; and
sending the profile for the NFc to the NFp, in response to the request.
   C2. The method of embodiment C1, further comprising performing a discovery procedure with the NFc to identify the NFp based on the first analytics ID.
   C3. The method of any of embodiments C1-C2, wherein one or more of the following applies:
the NFc is an analytics logical function of a network data analytics function, NWDAF (AnLF); and
the NFp is a model training logical function of the network data analytics function, NWDAF (MTLF).
   D1. A method for an analytics data repository function (ADRF) of a communication network, method comprising:
receiving, from a producer network function (NFp) of the communication network, a first request to store a machine learning (ML) model, wherein the first request includes a correlation identifier (ID) associated with the ML model and a universal resource locator (URL) associated with the NFp, from which the ML model can be obtained;
obtaining the ML model from the NFp using the URL associated with the NFp;
storing the obtained ML model in association with the correlation ID; and
sending to the NFp a first response including a URL associated with the ADRF, from which the ML model can be obtained.
   D2. The method of embodiment D1, further comprising:
receiving, from the NFp, an update request that includes the correlation ID and an allowed NF instance list; and
based on a match between the correlation ID included with the update request and the correlation ID stored in association with the ML model, storing the allowed NF instance list in association with the ML model, wherein the allowed NF instance list includes one or more identifiers associated with respective NFs of the communication network that are allowed to access the ML model.
   D3. The method of any of embodiments D1-D2, further comprising providing the ML model a consumer network function (NFc) of the communication network using the URL associated with the ADRF.
   D4. The method of embodiment D3, wherein providing the ML model to the NFc is based on match, correspondence, or relationship between an identifier associated with the NFc and an identifier included in an allowed NF instance list stored in association with the ML model.
   D5. The method of any of embodiments D3-D4, wherein one or more of the following applies:
the NFc is an analytics logical function of a network data analytics function, NWDAF (AnLF); and
the NFp is a model training logical function of the network data analytics function, NWDAF (MTLF).
   D6. The method of any of embodiments D1-D5, wherein the obtained ML model is encrypted and/or integrity-protected.
   E1. A consumer network function (NFc) of a communication network, wherein:
the NFc is implemented by communication interface circuitry and processing circuitry that are operably coupled; and
the processing circuitry and interface circuitry are configured to perform operations corresponding to any of the methods of embodiments A1-A8.
   E2. A consumer network function (NFc) of a communication network, the NFc being configured to perform operations corresponding to any of the methods of embodiments A1-A8.
   E3. A non-transitory, computer-readable medium storing computer-executable instructions that, when executed by processing circuitry associated with a consumer network function (NFc) of a communication network, configure the NFc to perform operations corresponding to any of the methods of embodiments A1-A8.
   E4. A computer program product comprising computer-executable instructions that, when executed by processing circuitry associated with a consumer network function (NFc) of a communication network, configure the NFc to perform operations corresponding to any of the methods of embodiments A1-A8.
   F1. A producer network function (NFp) of a communication network, wherein:
the NFp is implemented by communication interface circuitry and processing circuitry that are operably coupled; and
the processing circuitry and interface circuitry are configured to perform operations corresponding to any of the methods of embodiments B1-B9.
   F2. A producer network function (NFp) of a communication network, the NFp being configured to perform operations corresponding to any of the methods of embodiments B1-B9.
   F3. A non-transitory, computer-readable medium storing computer-executable instructions that, when executed by processing circuitry associated with a producer network function (NFp) of a communication network, configure the NFp to perform operations corresponding to any of the methods of embodiments B1-B9.
   F4. A computer program product comprising computer-executable instructions that, when executed by processing circuitry associated with a producer network function (NFp) of a communication network, configure the NFp to perform operations corresponding to any of the methods of embodiments B1-B9.
   G1. A network repository function (NRF) of a communication network, wherein:
the NRF is implemented by communication interface circuitry and processing circuitry that are operably coupled; and
the processing circuitry and interface circuitry are configured to perform operations corresponding to any of the methods of embodiments C1-C3.
   G2. A network repository function (NRF) of a communication network, the NRF being configured to perform operations corresponding to any of the methods of embodiments C1-C3.
   G3. A non-transitory, computer-readable medium storing computer-executable instructions that, when executed by processing circuitry associated with a network repository function (NRF) of a communication network, configure the NRF to perform operations corresponding to any of the methods of embodiments C1-C3.
   G4. A computer program product comprising computer-executable instructions that, when executed by processing circuitry associated with a network repository function (NRF) of a communication network, configure the NRF to perform operations corresponding to any of the methods of embodiments C1-C3.
   H1. An analytics data repository function (ADRF) of a communication network, wherein:
the ADRF is implemented by communication interface circuitry and processing circuitry that are operably coupled; and
the processing circuitry and interface circuitry are configured to perform operations corresponding to any of the methods of embodiments D1-D6.
   H2. An analytics data repository function (ADRF) of a communication network, the ADRF being configured to perform operations corresponding to any of the methods of embodiments D1-D6.
   H3. A non-transitory, computer-readable medium storing computer-executable instructions that, when executed by processing circuitry associated with an analytics data repository function (ADRF) of a communication network, configure the ADRF to perform operations corresponding to any of the methods of embodiments D1-D6.
   H4. A computer program product comprising computer-executable instructions that, when executed by processing circuitry associated with an analytics data repository function (ADRF) of a communication network, configure the ADRF to perform operations corresponding to any of the methods of embodiments D1-D6.

1-51. (canceled)

52. A method for a consumer network function (NFc) of a communication network, the method comprising:
registering the following with a network repository function (NRF) of the communication network:
a vendor identifier (ID) associated with the NFc, and
one or more analytics IDs associated with machine learning (ML) models supported by the NFc, including a first analytics ID associated with an ML model produced, owned, and/or maintained by a producer network function (NFp) of the communication network;
sending a request for the ML model to the NFp, wherein the request includes the first analytics ID and the vendor ID associated with the NFc; and
receiving from the NFp a response that includes a universal resource locator (URL) associated with a second NF of the communication network, from which the ML model can be obtained.

53. The method of claim 52, further comprising obtaining the ML model from the second NF using the URL.

54. The method of claim 52, wherein the second NF associated with the URL is one of the following: the NFp, or an analytics data repository function (ADRF).

55. The method of claim 52, further comprising performing second security operations on the ML model, wherein the second security operations correspond to the first security operations performed on the ML model by the NFp.

56. The method of claim 55, wherein:
the first security operations include one or more of the following: encryption, and integrity protection; and
the second security operations include one or more of the following: decryption corresponding to the encryption, and integrity checking corresponding to the integrity protection.

57. The method of claim 52, wherein the response from the NFp is based on a match, correspondence, or relationship between the following: the vendor ID registered with the NRF, and the vendor ID included in the request.

58. The method of claim 52, further comprising performing a discovery procedure with the NRF to identify the NFp based on the first analytics ID, wherein the request is sent responsive to the discovery procedure.

59. The method of claim 52, wherein one or more of the following applies:
the NFc is an analytics logical function of a network data analytics function, NWDAF (AnLF); and
the NFp is a model training logical function of the network data analytics function, NWDAF (MTLF).

60. A method for a producer network function (NFp) of a communication network, the method comprising:
receiving, from a consumer network function (NFc) of the communication network, a request for a machine learning (ML) model produced, owned, and/or maintained by the NFp, wherein the request includes the following:
a first analytics identifier (ID) associated with the ML model, and a vendor ID associated with the NFc;
obtaining a profile associated with the NFc from a network repository function (NRF) of the communication network;
authorizing the NFc to access the ML model based on a match, correspondence, or relationship between the following: a vendor ID included in the retrieved NF profile, and the vendor ID included in the request; and
based on authorizing the NFc, sending to the NFc a response that includes a universal resource locator (URL) associated with a second NF of the communication network, from which the ML model can be obtained.

61. The method of claim 60, wherein authorizing the NFC to access the ML model is further based on a match, correspondence, or relationship between the following:
the vendor ID included in the request, and an interoperability ID associated with the NFp and with the ML model.

62. The method of claim 60, further comprising, based on authorizing the NFc, updating an allowed network function (NF) instance list associated with the ML model to include an identifier associated with the NFc.

63. The method of claim 62, further comprising sending, to an analytics data repository function (ADRF) of the communication network, an update request that includes the following: the updated allowed NF instance list, and a correlation ID associated with the ML model.

64. The method of claim 60, wherein:
the second NF associated with the URL is the NFp; and
the method further comprises subsequently providing the ML model to the NFc using the URL associated with the NFp.

65. The method of claim 64, wherein providing the ML model to the NFc is based on a match, correspondence, or relationship between the following: an identifier associated with the NFc, and an allowed NF instance list associated with the ML model.

66. The method of claim 60, wherein:
the second NF associated with the URL is an analytics data repository function (ADRF) of the communication network; and
the method further comprises:
sending to the ADRF a first request to store the ML model, wherein the first request includes the following:
a correlation ID associated with the ML model, and
an URL associated with the NFp, from which the ML model can be obtained;
providing the ML model to the ADRF using the URL associated with the NFp; and
receiving from the ADRF a first response including the URL associated with the ADRF, which is sent to the NFc in the response.

67. The method of claim 66, wherein:
the method further comprises selecting an ADRF instance for storage of the ML model;
the ADRF instance is associated with an ADRF ID;
the first request is sent to the ADRF instance; and
providing the ML model to the ADRF is based on a match, correspondence, or relationship between the following: the ADRF ID, and the ADRF to which the ML model is provided.

68. The method of claim 60, further comprising performing first security operations on the ML model, wherein the first security operations include one or more of the following:
encryption, and integrity protection.

69. The method of claim 60, wherein one or more of the following applies:
the NFc is an analytics logical function of a network data analytics function, NWDAF (AnLF); and
the NFp is a model training logical function of the network data analytics function, NWDAF (MTLF).

70. A method for a network repository function (NRF) of a communication network, the method comprising:
registering the following information in a profile for a consumer network function (NFc) of the communication network:
a vendor identifier (ID) associated with the NFc, and
one or more analytics IDs associated with machine learning (ML) models supported by the NFc, including a first analytics ID associated with a first ML model produced, owned, and/or maintained by a producer network function (NFp) of the communication network;
receiving from the NFp a request for the profile for the NFc; and
sending the profile for the NFc to the NFp, in response to the request.

71. The method of claim 70, further comprising performing a discovery procedure with the NFc to identify the NFp based on the first analytics ID.

72. The method of claim 70, wherein one or more of the following applies:
the NFc is an analytics logical function of a network data analytics function, NWDAF (AnLF); and
the NFp is a model training logical function of the network data analytics function, NWDAF (MTLF).

73. A method for an analytics data repository function (ADRF) of a communication network, the method comprising:
receiving, from a producer network function (NFp) of the communication network, a first request to store a machine learning (ML) model, wherein the first request includes the following:
a correlation identifier (ID) associated with the ML model, and
a universal resource locator (URL) associated with the NFp, from which the ML model can be obtained;
obtaining the ML model from the NFp using the URL associated with the NFp;
storing the obtained ML model in association with the correlation ID; and
sending to the NFp a first response including a URL associated with the ADRF, from which the ML model can be obtained.

74. Network equipment configured to implement a consumer network function (NFc) of a communication network, wherein the network equipment comprises:
communication interface circuitry configured to communicate with network equipment that implements other network functions (NFs) of the communication network; and
processing circuitry operably coupled to the communication interface circuitry, wherein the processing circuitry and the communication interface circuitry are configured to perform the method of claim 52.

75. Network equipment configured to implement a producer network function (NFp) of a communication network, wherein the network equipment comprises:
communication interface circuitry configured to communicate with network equipment that implements other network functions (NFs) of the communication network; and
processing circuitry operably coupled to the communication interface circuitry, wherein the processing circuitry and the communication interface circuitry are configured to perform the method of claim 60.

76. Network equipment configured to implement network repository function (NRF) of a communication network, wherein the network equipment comprises:
communication interface circuitry configured to communicate with network equipment that implements other network functions (NFs) of the communication network; and
processing circuitry operably coupled to the communication interface circuitry, wherein the processing circuitry and the communication interface circuitry are configured to perform the method of claim 70.
